(19) United States
(12) Patent Application Publication
(10) Pub. No.: US 2013/0038128 A1
(43) Pub. Date: Feb. 14, 2013

(54) ELECTRONIC CIRCUIT AND MOBILE TERMINAL DEVICE USING THE SAME

(71) Applicant: Keisuke TAKAHASHI, Yokohama-shi (JP)

(72) Inventor: Keisuke TAKAHASHI, Yokohama-shi (JP)

(73) Assignee: RICOH COMPANY, LTD., Tokyo (JP)

(21) Appl. No.: 13/569,417

(22) Filed: Aug. 8, 2012

(30) Foreign Application Priority Data
Aug. 9, 2011 (JP) 2011-173977

(51) Int. Cl. H02H 3/06; H02J 9/00

(52) U.S. Cl. 307/64; 307/130

(57) ABSTRACT

An electronic circuit includes a first digital circuit, a second digital circuit, a first detection part to detect a first voltage value which is an operation voltage of the first digital circuit, a second detection part to detect a second voltage value which is an operation voltage of the second digital circuit, a comparison part to compare the first voltage value and the second voltage value, and a connection/disconnection part to perform connection and disconnection between the first digital circuit and the second digital circuit depending on a comparison result acquired by the comparison part.

### CROSS REFERENCE TO RELATED APPLICATION

This application is based on and claims the priority benefit of Japanese Patent Application No. 2011-173977, filed on Aug. 9, 2011, the disclosure of which is incorporated herein by reference in its entirety.

### BACKGROUND OF THE INVENTION

1. Field of the Invention

The present invention relates to an improvement in an electronic circuit and a mobile terminal device using the improved electronic circuit.

2. Description of the Related Art

In a logic circuit for a real time clock (RTC) to control clock information, an oscillation circuit produces an original oscillation clock signal and the logic circuit operates based on a frequency-dividing clock signal acquired by dividing the original oscillation clock signal. Here, the oscillation circuit can generally be operated by a source voltage lower than that supplied to the logic circuit, and a constant-voltage circuit to supply a stabilized source voltage to the oscillation circuit is often used.

In addition, in an instrument operated by a battery such as a mobile terminal device or the like, a power source for backup such as a coin-type secondary battery and so on supplying a source voltage to a constant-voltage circuit, logic circuit or the like is provided so that an integrated circuit (IC) for the real time clock (RTC) can control the clock information even if the battery is removed. However, because there is a limitation to a power in which the power source for backup can supply, it is demanded to reduce a consumption power of the IC for RTC in a backup operational mode.

In this way, the mobile terminal device has a backup function of the power source to hold the clock information. However, in recent years, for the purpose of further miniaturization and further low cost of the mobile terminal device, it is being mainstream that a condenser having a large capacity is substituted for the conventional coin-type secondary battery which has been used as backup of the power source.

In JP2010-113654A there is disclosed a technology in which, in an electronic circuit for real time clock (RTC) having no a switching circuit to switch a main power source and a backup power source, a value of a source voltage output from a constant-voltage circuit or operational period of the constant-voltage circuit is reduced, when the source voltage is not supplied from the main power source in accordance with a signal determining whether the source voltage is supplied from the main power source, to reduce a consumption power in a backup operational mode.

FIG. 3 illustrates a structure of a conventional electronic circuit. In FIG. 3, the electronic circuit 3 includes a secondary battery-charging power source LDO3 33 to produce a power source LDO3 (3.0V) for charging a secondary battery 36 based on a system power source (VSYS), a backup digital circuit (RVDD-system logic circuit) 34 operated by the secondary battery 36, a LODIG power source 31 to supply a LDODIG (1.8V) to a VINT (DVDD-system) logic circuit 32 based on the system power source (VSYS), and a VREF 37 to generate a standard voltage based on the system power source (VSYS).

Because the DVDD-system logic circuit 32 and the RVDD-system circuit 34 are composed of a MOS (Metal Oxide Semiconductor) transistor, a voltage (1.8V) is supplied to the DVDD-system logic circuit 32 and a voltage (3.0V) is not supplied to the RVDD-system circuit 34, an input of a MOS logic of the DVDD-system logic circuit 32 is in an opened state, a gate voltage is indefinite. Therefore, an indefinite signal is transmitted from the RVDD-system circuit 34 to the DVDD-system logic circuit 32, thereby there is possibility of malfunction in which an unexpected abnormal current flows in the DVDD-system logic circuit 32.

To prevent this state, there is provided isolation 30 to perform disconnection and connection between the DVDD-system logic circuit 32 and the RVDD-system logic circuit 34 such that a signal is transmitted from the RVDD-system logic circuit 34 to the DVDD-system logic circuit 32 at a time when a voltage of the RVDD-system logic circuit 34 arrives a predetermined voltage (a degree of 3V).

The disconnection and the connection (hereinafter, referred to as, also, detection and cancellation of the isolation) between the DVDD-system logic circuit 32 and the RVDD-system logic circuit 34 are implemented by comparing voltages divided by sense resistances 38 and 39 with a standard voltage (VREF) 37 in a detection circuit (simple DET) 35.

That is to say, when a voltage value of the DVDD-system logic circuit 32 and a voltage value of the RVDD-system logic circuit 34 have a relationship of the voltage value of the DVDD-system logic circuit 32 the voltage value of the RVDD-system logic circuit 34, the detection of the isolation is performed, or the transmission of the signal is turned OFF, whereas when the voltage value of the DVDD-system logic circuit 32 and the voltage value of the RVDD-system logic circuit 34 have a relationship of the voltage value of the DVDD-system logic circuit 32<the voltage value of the RVDD-system logic circuit 34, the cancellation of the isolation is performed, or the transmission of the signal is turned ON, thereby the disconnection and the connection between the DVDD-system logic circuit 12 and the RVDD-system logic circuit 14 in the isolation 30 are implemented.

In this way, it has conventionally been implemented to provide the detection circuit 35 and the sense resistances 38 and 39 to isolate the DVDD-system logic circuit 32 and the RVDD-system logic circuit 34.

However, in the semiconductor integrated circuit disclosed in JP2010-113654, it is an object thereof to reduce a consumption power in a backup operational mode, but there is a problem that logic circuits are complicate in structure because a control is performed by an intermittent signal determining whether a source voltage is supplied from a main power source.

In addition, in a conventional electronic circuit as shown in FIG. 3, the sense resistances 38 and 39 provided to isolate the DVDD-system logic circuit 32 and the RVDD-system logic circuit 34 have a resistance component of a degree of several ten MQ to reduce as much as possible consumption current associated with voltage dividing.

In contrast, a mobile terminal device, even in a state where a user removes a rechargeable battery pack, has a structure necessary to hold a clock function about one minute. A coin-type secondary battery is conventionally used as a power source for backup. However, a condenser having a capacitance of about 47 μF is substituted for the coin-type secondary battery to accomplish miniaturization and low cost of the mobile terminal device itself.

On the other hand, because the sense resistances have the resistance component of about several ten MQ, wasted current is consumed. This consumption has influence in any way to backup performance of the power source. Therefore, it is necessary to determine the capacitance of the condenser in view of this uneconomically wasted current to maintain the backup performance. As the capacitance of the condenser increases, a size of the condenser tends to increase. Consequently, there is a problem that increasing the capacitance of condenser goes against the course of events of the miniaturization and the low cost of the mobile terminal device.

### SUMMARY OF THE INVENTION

An object of the present invention is to provide an electronic circuit capable of accomplishing miniaturization and low cost without increasing a capacitance and a size of a condenser while performing isolation between a DVDD-system logic circuit and an RVDD-system logic circuit, and a mobile terminal device using the electronic circuit

To accomplish the above object, an electronic circuit according to an embodiment of the present invention includes a first digital circuit, a second digital circuit, a first detection part to detect a first voltage value which is an operation voltage of the first digital circuit, a second detection part to detect a second voltage value which is an operation voltage of the second digital circuit, a comparison part to compare the first voltage value and the second voltage value, and a connection/disconnection part to perform the connection and the disconnection between the first digital circuit and the second digital circuit depending on a co p on result acquired by the comparison part.

### BRIEF DESCRIPTION OF THE DRAWINGS

FIG. 1 is a block view showing an electronic circuit according to an embodiment of the present invention.

FIG. 2 is a view showing a relationship a voltage value of the electronic circuit and detection, connection and disconnection in isolation, in the embodiment of the present invention.

FIG. 3 is a block view showing a circuit configuration of a conventional electronic circuit.

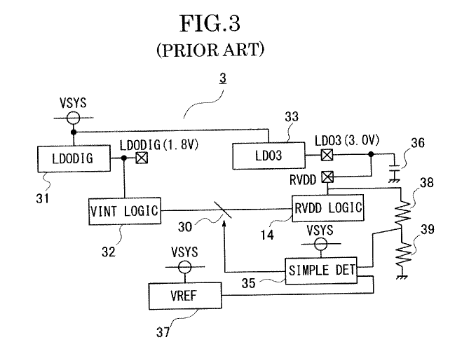

### DETAILED DESCRIPTION OF THE PREFERRED EMBODIMENTS

Preferred embodiments of the present invention will be explained hereinafter in detail with reference to the accompanying drawings.

Throughout the drawings, identical reference numbers are attached to similar parts, a duplicative description is omitted.

In an embodiment according to the present invention, miniaturization and low cost of an electronic circuit and a mobile terminal device using the same can be accomplished without increasing a capacitance and a size of a condenser while performing detection, connection, and disconnection of isolation. In other words, in the embodiment, by omitting the resistances used in the conventional electronic circuit in providing a detection circuit or simple detection circuit (simple DET) and comparing voltage values of logic circuits directly, it is possible to perform the detection and the disconnection of the isolation and accomplish miniaturization and low cost of an electronic circuit and a mobile terminal device using the electronic circuit, without increasing a consumption current at the time of a backup operation mode and increasing a capacitance and a size of a condenser.

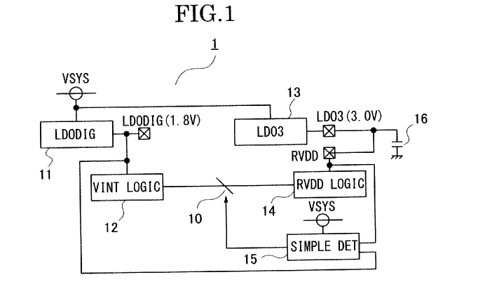

FIG. 1 illustrates a block view of an electronic circuit according to the embodiment.

In FIG. 1, the electronic circuit 1 includes a first digital circuit 12, a second digital circuit 14, a condenser-charging power source LDO3 13 to produce a power source LDO3 (3.0V) to charge a condenser 16 based on a system power source VSYS, and a LODIG power source 11.

The first digital circuit 12, for example, comprises a VINT (DVDD-system) logic circuit 12 to which a power of LDODIG (1.8V) is supplied based on the system power source VSYS. The second digital circuit 14, for example, comprises a backup digital circuit (RVDD-system logic circuit) operated by the condenser 16.

The electronic circuit includes a detection circuit 15 which includes a first detection part to detect a first voltage value which is an operational voltage of the first digital circuit, that is, the DVDD-system logic circuit 12, a second detection part to detect a second voltage value which an operational voltage of the second digital circuit 14, that is, the RVDD-system logic circuit 14, a comparison part to compare the first voltage value and the second voltage value, and a disconnection and connection part to disconnect and connect between the DVDD-system logic circuit 12 and the RVDD-system logic circuit 14 depending on a compared result acquired by the comparison part.

Because the DVDD-system logic circuit 12 and the RVDD-system logic circuit 14 are composed of a MOS transistor, when the power (1.8V) is supplied to the DVDD-system logic circuit 12 and the power (3.0V) is not supplied to the RVDD-system logic circuit 14, an input to the MOS logic of the DVDD-system logic circuit 12 is in an opened state. This results in an unstable gate voltage. Therefore, a signal for an unstable voltage is transmitted from the RVDD-system logic circuit 14 to the DVDD-system logic circuit 12, there is possibility that an unexpected abnormal current flows into the DVDD-system logic circuit 12 (hereinafter, referred to as unstable state).

To prevent, this state, there is provided isolation 10 to perform disconnection and connection between the DVDD-system logic circuit 12 and the RVDD-system logic circuit 14 such that a signal is transmitted from the RVDD-system logic circuit 14 to the DVDD-system logic circuit 12 at a time when a voltage of the RVDD-system logic circuit 14 arrives a predetermined voltage (a degree of 3V). The disconnection and the connection are achieved by the disconnection and connection part provided in the detection circuit 15.

The disconnection and the connection (hereinafter, referred to as, also, detection and cancellation of the isolation) between the DVDD-system logic circuit 12 and the RVDD-system logic circuit 14 are achieved by comparing directly the operational voltage of the DVDD-system logic circuit 12 and the operational voltage of the RVDD-system logic circuit 14 in the detection circuit (simple DET) 15.

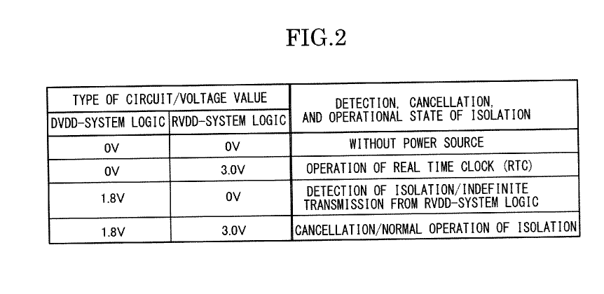

Here, a relationship between a voltage value of each logic circuit and the detection and cancellation of the isolation and an operational state of the logic circuit is explained with reference to FIG. 2.

FIG. 2 illustrates a relationship a voltage value of each logic circuit, and the detection and the cancellation of the isolation and the operational state.

In FIG. 2, when the operational voltages of the DVDD-system logic circuit 12 and the RVDD-system logic circuit 14 are together zero, a power is at all not supplied to the DVDD-system logic circuit 12 and the RVDD-system logic circuit 14. On the other hand, when the DVDD-system logic circuit 12 has zero (0) operational voltage and the RVDD-system logic circuit 14 has the operational voltage of 3V, because this state is a case where a power is supplied from the condenser 16 to only the RVDD-system logic circuit 14 which is the backup digital circuit, only a real time clock (RTC) at the time of a backup operational mode is operated.

When the operational voltage of the DVDD-system logic circuit 12 is 1.8V and the operational voltage of the RVDD-system logic circuit 14 is zero (0), because this state is the indeterminate state as mentioned above, the disconnection (detection of the isolation) between the DVDD-system logic circuit 12 and the RVDD-system logic circuit 14 is achieved by controlling the isolation 10 by the detection circuit 15.

Finally, when the operational voltage of the DVDD-system logic circuit 12 is 1.8V and the operational voltage of the RVDD-system logic circuit 14 is 3.0V, because this state is a normal operational state where a power is supplied to the DVDD-system logic circuit 12 and the RVDD-system logic circuit 14. At this time, the connection (cancellation of the isolation) between the DVDD-system logic circuit 12 and the RVDD-system logic circuit 14 is established by controlling the isolation 10 by the detection circuit 15.

That is to say, when the voltage value of the DVDD-system logic circuit 12 and the voltage value of the RVDD-system logic circuit 14 have a relationship of the voltage value of the DVDD-system logic circuit 12 the voltage value of the RVDD-system logic circuit 14, the detection of the isolation is performed, or the transmission of the signal is turned OFF, whereas when the voltage value of the DVDD-system logic circuit 12 and the voltage value of the RVDD-system logic circuit 14 have a relationship of the voltage value of the DVDD-system logic circuit 12<the voltage value of the RVDD-system logic circuit 14, the cancellation of the isolation is performed, or the transmission of the signal is turned ON, thereby the disconnection and the connection between the DVDD-system logic circuit 12 and the RVDD-system logic circuit 14 are implemented.

In this way, in the embodiment, the voltage value of the DVDD-system logic circuit 12 and the voltage value of the RVDD-system logic circuit 14 are directly compared in the detection circuit 15, and depending on a compared result, the disconnection and the connection (the detection and the cancellation of the isolation) between the DVDD-system logic circuit 12 and the RVDD-system logic circuit 14 are implemented.

Sense resistances which have conventionally been used for comparing voltage values in a detection circuit are eliminated, consequently, because there is no need considering a wasted current, it is possible to accomplish miniaturization and low cost of the electronic circuit as a whole, without increasing a capacitance and a size of the condenser to operate a backup mode.

In addition, because a wasted current in the conventional sense resistances does not occur, at the time of the backup operational mode and further even in the normal operational state, a consumption current of the entire electronic circuit can be reduced. Furthermore, because the miniaturization and the low cost of the electronic, in particular, the logic circuits can be accomplished, it is possible to achieve miniaturization and low cost of the entirety of a mobile terminal device on which the electronic circuit or logic circuits are mounted.

In this way, in the embodiment as mentioned above, by omitting the resistances used in the conventional electronic circuit in providing a detection circuit (simple DET) and comparing voltage values of logic circuits directly, it is possible to achieve the detection and the disconnection of the isolation and accomplish miniaturization and low cost of an electronic circuit and a mobile terminal device using the electronic circuit, without increasing a consumption current at the time of a backup operation mode and increasing a capacitance and a size of a condenser.

Although the preferred embodiments of the present invention have been described, it should be understood that the present invention is not limited to these embodiments, various modifications and changes can be made to the embodiments.

What is claimed is:

1. An electronic circuit, comprising
a first digital circuit;
a second digital circuit;
a first detection part to detect a first voltage value which is an operation voltage of the first digital circuit;
a second detection part to detect a second voltage value which is an operation voltage of the second digital circuit;
a comparison part to compare the first voltage value and the second voltage value; and
a connection/disconnection part to perform the connection and the disconnection between the first digital circuit and the second digital circuit depending on a comparison result acquired by the comparison part.

2. The electronic circuit according to claim 1, wherein the connection/disconnection part is configured to disconnect between the first digital circuit and the second digital circuit when a comparison result in which the first voltage value is equal to or more than the second voltage value is acquired by the comparison part.

3. The electronic circuit according to claim 1, wherein the connection/disconnection part is configured to connect between the first digital circuit and the second digital circuit when a comparison result in which the second voltage value is more than the first voltage value or more is acquired by the comparison part.

4. The electronic circuit according to claim 1,
further comprising a condenser which functions as a power source for backup of the second digital circuit.

5. The electronic circuit according to claim 4, wherein the condenser is charged by the second voltage value.

6. The electronic circuit according to claim 4, wherein the power source for backup is configured to drive a real time clock.

7. A mobile terminal device comprising the electronic circuit as recited in claim 1.
